(19) United States
(12) Patent Application Publication
(10) Pub. No.: US 2003/0062174 A1
(43) Pub. Date: Apr. 3, 2003

(54) Method for collecting and eliminating flying dust

(75) Inventors: Matteo Passoni, Milan (IT); Carlo Guido Passoni, Gorgonzola (IT)

Correspondence Address: YOUNG & THOMPSON, 745 SOUTH 23RD STREET 2ND FLOOR, ARLINGTON, VA, 22202

(73) Assignee: ECOLOGY S.R.L., MILAN (IT)

(21) Appl. No.: 10/096,510

(22) Filed: Mar. 13, 2002

(30) Foreign Application Priority Data
Oct. 3, 2001 (IT) MI2001A 002052

(51) Int. Cl. A62C 2/00

(52) U.S. Cl. 169/46; 169/54

(57) ABSTRACT

A method for collecting and eliminating flying dust and for fire extinguishing use, characterised by spraying the space concerned by jets of air to which water and possibly surfactant have been added by injection into said jets.

The present invention relates to a method for collecting and eliminating flying dust and for fire extinguishing use, and the apparatus for implementing it.

As is well known, flying dust represents a serious danger both for people and for the environment.

Various attempts have been made to solve the problem, for example by collecting the dust by suction and passing it through suitable filters (requiring constant maintenance). Such a solution can achieve a certain result if applied to closed or substantially closed environments, but is certainly not feasible in open zones such as roads, yard areas and the like.

An object of the invention is to solve the problem of collecting and eliminating flying dust present in open zones without the need to use filters or means which in their turn can give rise to pollution. Another object of the invention is to effectively solve the problem of extinguishing fires.

These and further objects which will be apparent from the ensuing detailed description are attained by a method and apparatus in accordance with the teachings of the accompanying claims.

The invention will be more apparent from the ensuing detailed description of a preferred embodiment thereof, provided by way of non-limiting example and illustrated in the accompanying drawing, in which:

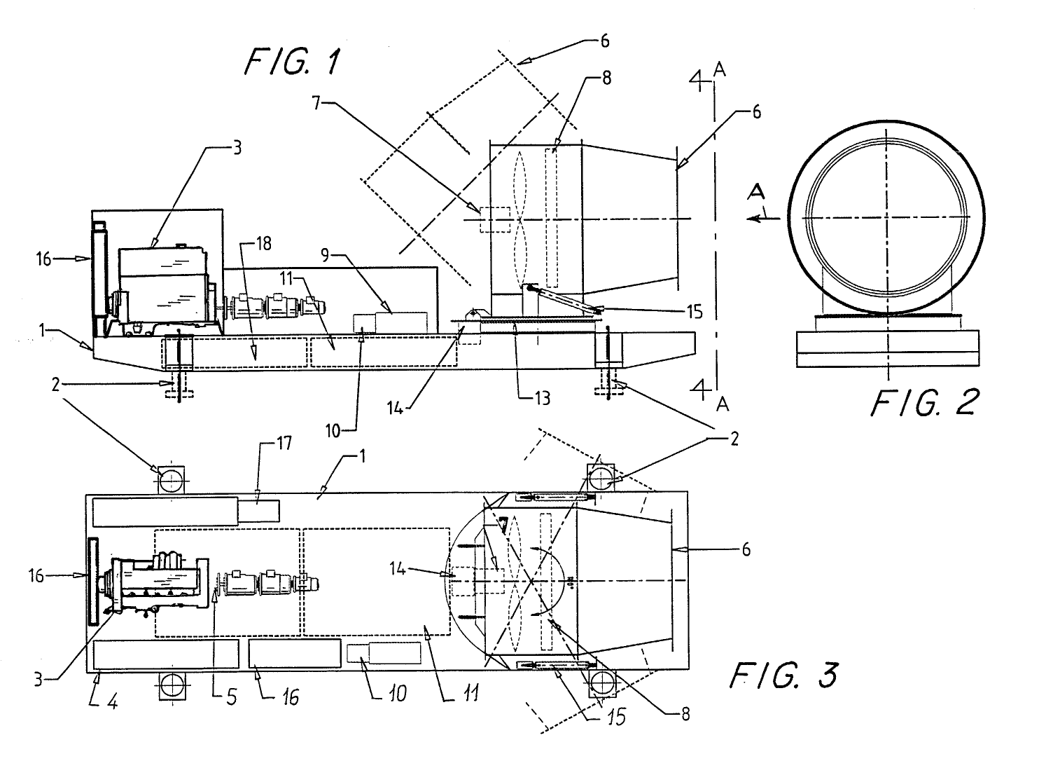

FIG. 1 is a schematic side elevation of an apparatus according to the invention;

FIG. 2 is a front schematic view of the apparatus in the direction of the arrow A;

FIG. 3 is a schematic plan view of the apparatus;

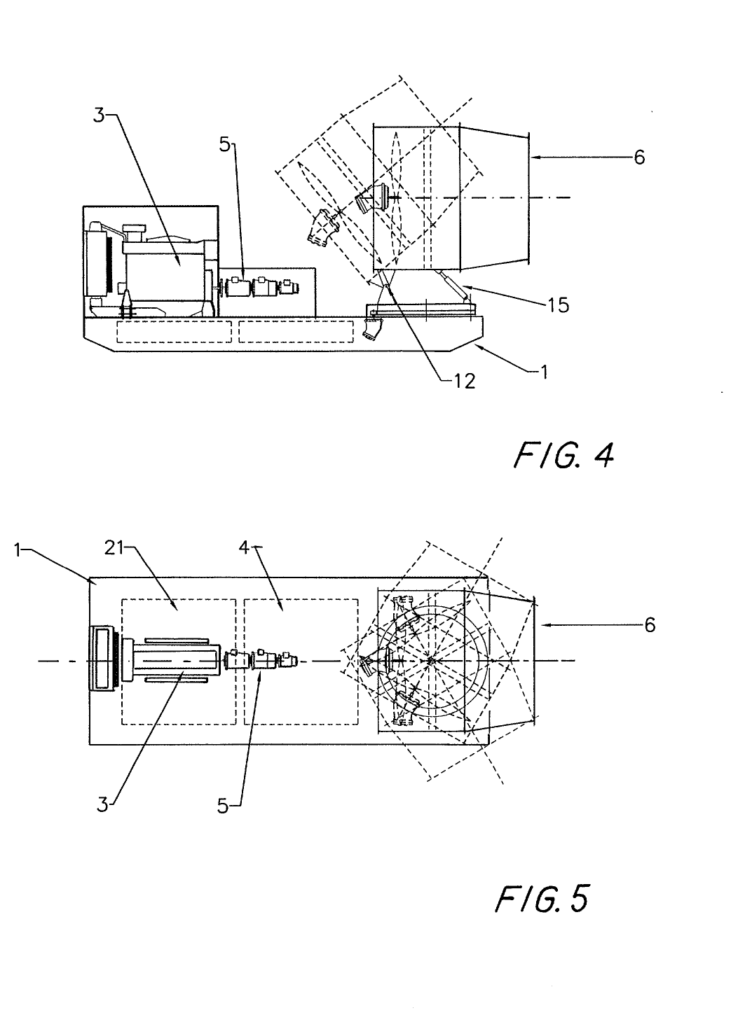

FIGS. 4 and 5 are a more schematic side elevation and plan view of the apparatus with some parts omitted, said two figures illustrating the facility for orientating the so-called “propellant” part of the apparatus.

The method of the invention consists essentially of collecting and eliminating the flying dust by striking the open area containing this flying dust with a jet of atomized water, the water being either alone or mixed with an active ecological surfactant (known per se).

By suitably dimensioning the apparatus to be described, the jet can be propelled to a distance of 250 metres or more.

The apparatus of the invention, shown here by way of example in the drawings, consists of an easily transportable module (of relatively small dimensions when assembled, for example 2.4 m wide by 7 m long and by about 2.8 m high) which is easy to locate on any suitable surface.

The module in question comprises a base 1 for example of structural metalwork, provided where necessary with adjustable stabilizers 2 and defining a platform, or with lockable wheels, or only a fixed base with just the blower and nozzles.

On this platform there is mounted a conventional electric motor or preferably a diesel engine 3 drawing the necessary fuel from a tank 4 (FIG. 3) located on the platform or incorporated into the base 1. The engine 3 operates a series of preferably coaxial oil pumps (FIG. 5), the function of which is described hereinafter.

On the platform the is also mounted a tube-encased blower 6 operated by a rotary hydraulic motor 7 connected to a pump of the pump series 5. The hydraulic motor 7 can be replaced by an electric motor powered by the external mains or by an auxiliary proximity generator. If the diesel engine 3 is provided, this can be connected to an electric generator which powers the electric motor provided for operating the blower.

The air jet produced by the blower strikes particles of water (with or without surfactant) fed through one or more rings of nozzles 8. These nozzles are fed by a pump operated by a hydraulic motor 10 operationally connected to one of the pumps of the pump series 5. The pump 9 and the hydraulic motor 10 are both mounted on the platform. The pump 9 draws the water or the water-surfactant solution from a tank incorporated into the base 1.

On the platform there is also mounted a tank 18 for the oil, which is withdrawn by the pumps of the series 5 and returned to the tank from the hydraulic motors connected to these pumps.

As can be seen from FIGS. 1, 2, 4 and 5 in particular, the blower 6 can be swivelled (i.e. rotated about a vertical axis), and can also be inclined about a horizontal axis. In detail, the blower 6 is mounted rotatable on a horizontal joint 12 supported by a rotatable platform 13 supported by a thrust bearing (not visible) provided on the base. The rotatable platform 13 presents a peripheral toothing (not visible) with which there engages a gearwheel (also not visible) operated by a rotary hydraulic motor 14 mounted in the base 1. To achieve rotation about the axis of the joint 12, hydraulic actuators 15 are provided connected for example by their rod to the blower and by their cylinder to the rotatable platform 13. Both the rotary hydraulic motor 14 and the actuators 15 are fed by pumps of the pump series 5 (via valve members to control the described movements). A conventional radiator 16 for the diesel engine 3 and a heat exchanger 17 for cooling the oil are also present on the platform.

The module operation can be automated electronically and be also arranged for remote radio control.

The module operation comprises control of the approach and adjustment of the engine 3, control of the raising and swivelling of the blower, control of the speed of the blower 6, and control of the delivery pressure of the pump 9.

The method for collecting and eliminating flying dust is implemented in a apparatus which produces and propels a two- or three-phase fluid jet composed of air and water with or without surfactant, for distribution within the surrounding environment with uniformity of distribution and precipitation throughout the zone of the jet from the vicinity of the blower to 250 metres therefrom, to depolverize a plan area of up to about 130,000 m² and enable the particles of flying dust to undergo agglomeration and increase in weight, so that they precipitate to the ground within the area of influence and avoid their inhalation by surrounding persons and pollution of adjacent areas.

The apparatus can also be used for extinguishing fires, and has demonstrated absolute effectiveness during tests carried out in industrial and woodland applications.

The various drives for operating the blower can be electric and/or hydraulic motors possibly powered by a generator operated by the diesel engine 3, or in the case of hydraulic motors the diesel engine 3 would operate the hydraulic pumps for activating the circuit. If the situation allows it, the electric motors could be connected to the mains.

1. A method for collecting and eliminating flying dust and for fire extinguishing use, characterised by spraying the space concerned by jets of air to which water has been added by injection into said jets.

2. A method as claimed in claim 1, characterised by comprising the formation of a jet of air and injecting water in particle form thereinto.

3. A method as claimed in the preceding claims, wherein surfactant is added to the water.

4. A method as claimed in the preceding claims, wherein a particulate aqueous solution of surfactant as well as particulate water itself is injected into the jet.

5. An apparatus for implementing the method, characterised by comprising a means for generating a jet of air, and means for injecting water and possibly also surfactant into said jet.

6. An apparatus as claimed in claim 5, characterised in that said means for generating a jet of air is a blower.

7. An apparatus as claimed in claims 4 and/or 5, wherein the means for injecting water into the jet of air are nozzles.

8. An apparatus as claimed in one or more of claims 5-7, characterised in that the blower and the injector nozzles form part of a module which comprises the means for feeding the nozzles and the means for operating the blower.

9. An apparatus as claimed in one or more of claims 5-8, characterised in that the module comprises a prime mover, preferably a diesel engine, for operating the blower and feeding the nozzles.

10. An apparatus as claimed in claim 9, characterised in that the prime mover operates the blower via an oil pump and hydraulic motor.

11. An apparatus as claimed in claim 9 or claims 9 and 10, characterised in that the prime mover feeds the nozzles via an oil pump and hydraulic motor, this latter operating a pump for feeding the nozzles.

12. An apparatus as claimed in one or more of the preceding claims, characterised in that the blower can be swivelled and inclined.

13. An apparatus as claimed in claim 12, characterised by comprising means for effecting the swivelling and inclination of the blower.

14. An apparatus as claimed in the preceding claims, characterised in that the means for effecting the inclination comprise hydraulic actuators and the means for effecting the swivelling comprise a rotary hydraulic motor fed by a pump operated by the prime mover.

15. An apparatus as claimed in at least one of claims 5-14, characterised in that the rotary hydraulic motor for swivelling the blower is linked to this latter by gearwheels.

16. An apparatus as claimed in one or more of the preceding claims, wherein the blower is operated by an electric motor.

17. An apparatus as claimed in one or more of the preceding claims, wherein the pump which feeds the nozzles is operated by an electric motor.

18. An apparatus as claimed in one or more of the preceding claims, wherein the diesel engine operates at least one electric generator powering at least one electric motor.
